(19) United States
(12) Patent Application Publication
(10) Pub. No.: US 2026/0340005 A1
(43) Pub. Date: Oct. 29, 2026

(54) SYSTEMS AND METHODS FOR GENERATIVE ARTIFICIAL INTELLIGENCE INTAKE TOOL

(71) Applicant: State Farm Mutual Automobile Insurance Company, Bloomington, IL (US)

(72) Inventors: Ajay Kulkarni, Bloomington, IL (US); Sona Sandeep Patel, Bloomington, IL (US); Gautam Bagade, Bloomington, IL (US)

(73) Assignee: State Farm Mutual Automobile Insurance Company, Bloomington, IL (US)

(21) Appl. No.: 19/191,303

(22) Filed: Apr. 28, 2025

(51) Int. Cl. G06F 16/334; G06F 16/353; G06F 21/31; G06F 21/62

(52) U.S. Cl. CPC G06F 16/334; G06F 16/353; G06F 21/31; G06F 21/6227

(57) ABSTRACT

A method for scoring and prioritizing data intake forms, the method including receiving text data corresponding to one or more queries from a user device, analyzing the one or more queries associated with the text data, utilizing one or more score generator algorithms to generate one or more scores associated with the one or more queries, prioritizing the text data based on the one or more scores, generating snapshot data based on the one or more scores associated with the one or more queries, and transmitting the snapshot data to the user device.

### TECHNICAL FIELD

Various embodiments of the present disclosure relate generally to systems and methods for scoring and prioritizing data intake forms.

### BACKGROUND

Data intake tools used across enterprises may be time and resource intensive, relying on manual review and prioritization of each submission. The process may include multiple individuals in leadership roles manually reviewing, scoring, and prioritizing each submission. The process may delay and impact the decisions made by the enterprise. Each decision may be determined in a different manner leading to inconsistencies across the submission and decision process. Additionally, each user who submits a data submission may not be able to view the status of the data submission and/or the respective outcomes. As a result, a need exists to quickly and efficiently analyze enterprise submissions to properly score and prioritize each submission.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for classifying insurance claims instances. More specifically, the disclosure may include methods and systems for training and utilizing artificial intelligence for classifying and prioritizing insurance claims instances.

In some aspects, the techniques described herein relate to a computer-implemented method for intake scoring, the computer-implemented method including receiving, by one or more processors, text data corresponding to one or more queries from a user device. The method may further include analyzing, by the one or more processors, the one or more queries associated with the text data. The method may further include utilizing, by the one or more processors, one or more score generator algorithms to generate one or more scores associated with the one or more queries. The method may further include prioritizing, by the one or more processors, the text data based on the one or more scores. The method may further include generating, by the one or more processors, snapshot data based on the one or more scores associated with the one or more queries. The method may further include transmitting, by the one or more processors, the snapshot data to the user device.

In some aspects, the techniques described herein relate to a system for prioritization scoring, the system comprising a memory storing instructions, one or more machine-learning models trained to determine prioritization scoring, a processor operatively connected to the memory and configured to execute instructions to perform: receiving text data corresponding to one or more queries from a user device. The system may further include analyzing the one or more queries associated with the text data. The system may further include utilizing one or more score generator algorithms to generate one or more scores associated with the one or more queries. The system may further include prioritizing the text data based on the one or more scores. The system may further include generating snapshot data based on the one or more scores associated with the one or more queries. The system may further include transmitting the snapshot data to the user device.

In some aspects, the techniques described herein relate to a non-transitory computer readable medium configured to store processor readable instructions, wherein when executed by a processor, the instructions perform operations comprising: receiving text data corresponding to one or more queries from a user device. The non-transitory computer readable medium may further include analyzing the one or more queries associated with the text data. The non-transitory computer readable medium may further include utilizing one or more score generator algorithms to generate one or more scores associated with the one or more queries. The non-transitory computer readable medium may further include prioritizing the text data based on the one or more scores. The non-transitory computer readable medium may further include generating snapshot data based on the one or more scores associated with the one or more queries. The non-transitory computer readable medium may further include transmitting the snapshot data to the user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing environment that may be utilized with techniques presented herein, according to one or more embodiments.

FIG. 2 depicts a diagram of an exemplary flow for intake scoring, according to one or more embodiments.

FIG. 3 depicts a diagram of another exemplary flow for intake scoring, according to one or more embodiments.

FIG. 4 depicts a diagram of prioritization of an exemplary flow for intake scoring of FIG. 3, according to one or more embodiments.

FIG. 5 depicts a diagram of another exemplary flow for intake scoring, according to one or more embodiments

FIG. 6 depicts a flowchart of an exemplary method for intake scoring, according to one or more embodiments.

FIG. 7 depicts an exemplary welcome user interface for intake scoring, according to one or more embodiments.

FIGS. 8A and 8B depict exemplary user interfaces for intake scoring, according to one or more embodiments.

FIG. 9 depicts an exemplary user submission dashboard user interface, according to one or more embodiments.

FIG. 10 depicts an exemplary user submission interface, according to one or more embodiments.

FIG. 11 depicts an exemplary metrics dashboard user interface for intake scoring, according to one or more embodiments.

FIG. 12 depicts a flowchart of an exemplary method for training a machine-learning model to determine how to route each claim insurance instance to an appropriate claims representative, according to one or more embodiments.

FIG. 13 depicts an exemplary computer system that may execute techniques presented herein, according to one or more embodiments.

### DETAILED DESCRIPTION OF EMBODIMENTS

According to certain aspects of the disclosure, systems and methods for training and utilizing artificial intelligence for scoring and prioritizing intake submissions are disclosed.

Data intake tools used across enterprises are time and resource intensive, relying upon manual review and prioritization of each submission. The process may include multiple individuals in leadership roles manually reviewing, scoring, and prioritizing each submission. The process may delay and impact the decisions made by the enterprise. Each decision may be determined in a different manner, which may lead to inconsistencies across the submission and decision process. Additionally, each user who submits a data submission may not be able to view the status of the submission and the respective outcomes. As a result, a need exists to quickly and efficiently analyze enterprise submissions to properly score and prioritize each submission.

To streamline this process, machine-learning and artificial intelligence (AI) technologies may be employed to enhance the efficiency and accuracy of the intake submission process. A system using a combination of machine-learning and AI may effectively score and prioritize a plurality of intake submissions to align with business goals.

The claimed systems and methods may utilize a plurality of scoring categories (e.g., value at stake, technical complexity, risk, repeatability, and/or enterprise categories) to indicate a priority of each intake submission. One or more machine-learning models may analyze the intake submission, including text data, to determine an intake submission's rating, in order to prioritize the intake submission relative to other intake submissions and the enterprise's current business goals. In addition, the claimed systems and methods may display each intake submission and the respective prioritization on a user device for review.

The claimed systems and methods may increase the efficiency and accuracy of the intake submission process by utilizing machine-learning models and AI to gather information and determine relationships between the intake submissions and the business goals to decrease the intake submission process length and needed resources.

As will be described in more detail below, in various embodiments, systems and methods are described for intake scoring. The systems and methods may include receiving, by one or more processors, text data corresponding to one or more queries from a user device. The systems and methods may further include analyzing, by the one or more processors, the one or more queries associated with the text data. The systems and methods may further include utilizing, by the one or more processors, one or more score generator algorithms to generate one or more scores associated with the one or more queries. The systems and methods may further include prioritizing, by the one or more processors, the text data based on the one or more scores. The systems and methods may further include generating, by the one or more processors, snapshot data based on the one or more scores associated with the one or more queries. The systems and methods may further include transmitting, by the one or more processors, the snapshot data to the user device.

### Exemplary Environment

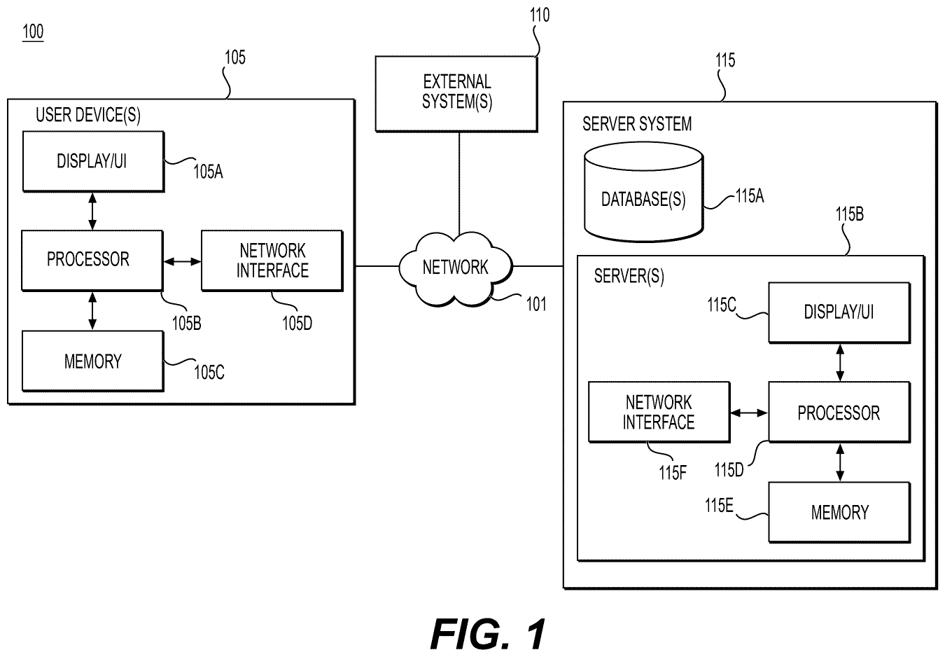

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a machine-learning model to determine how to score and prioritize each intake submission.

In one embodiment, the components of the environment 100 are associated with a common entity. In one embodiment, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to determine how to score and prioritize each intake submission, among other activities.

The user device 105 may be configured to enable the user to access and/or interact with other systems in the environment 100. For example, the user device 105 may be a computer system such as, for example, a desktop computer, a mobile device, a tablet, etc. In one embodiment, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In one embodiment, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various natural language instruction tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In one embodiment, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In one embodiment, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third-party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to determine how to score and prioritize each intake submission. The server system 115 may include a machine-learning model and/or instructions associated with the machine-learning model, e.g., instructions for generating a machine-learning model, training the machine-learning model, using the machine-learning model, etc. The server system 115 may include instructions for processing natural language email instructions, e.g., based on the output of the machine-learning model, and/or operating the display/UI 115C to output an action, e.g., as adjusted based on the machine-learning model. The server system 115 may include training data, e.g., a training text data, scoring data, business entity data, one or more labels, and/or one or more rules.

In one embodiment, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In one embodiment, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the text data, scoring data, business entity data, labels, and rules, such that the trained machine-learning model is configured to determine how to score and prioritize each intake submission based on the learned associations.

In various embodiments, the variables of a machine-learning model may be interrelated in any suitable arrangement in order to generate the output. For example, the machine-learning model may include one or more convolutional neural network (“CNN”) configured to determine contextual information relating to an intake submission, and may include further architecture, e.g., a connected layer, neural network, etc., configured to determine a relationship between the identified features in order to determine contextual information.

In various embodiments, the variables of a machine-learning model may be interrelated in any suitable arrangement in order to generate the output. For example, the machine-learning model may include one or more recurrent neural network (“RNN”) configured to determine images across a series of time, and may include further architecture, e.g., a connected layer, neural network, etc., configured to determine a relationship between the identified features in order to determine potential damage over the period of time.

Further aspects of the machine-learning model and/or how it may be utilized to process natural language queries in further detail in the method below. In the following methods, various acts may be described as performed or executed by a component from FIG. 1, such as the server system 115, the user device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

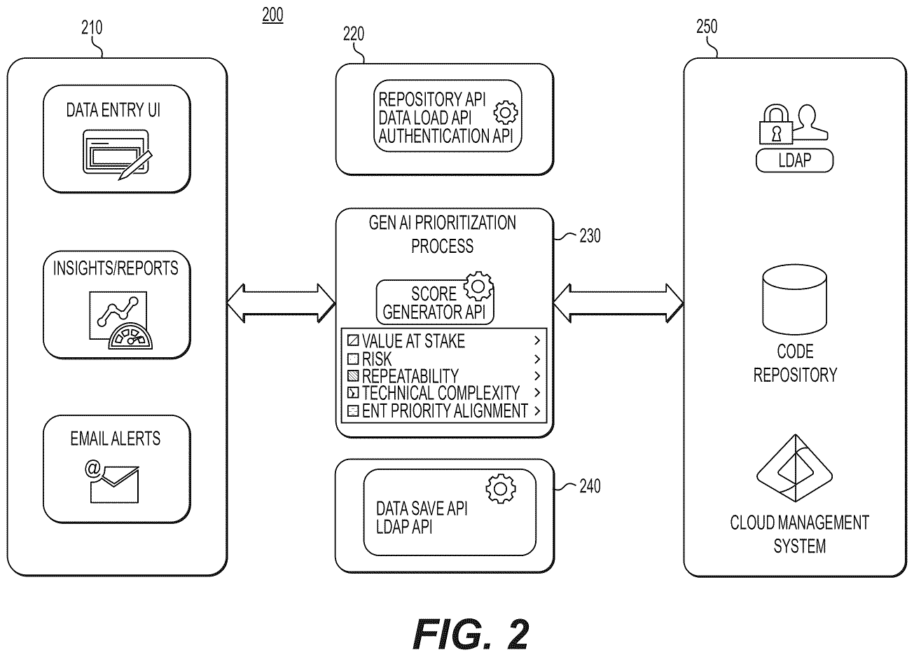

In general, any process or operation discussed in this disclosure that is understood to be computer-implementable, such as the process illustrated in FIGS. 2-6, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in one embodiment, be integrated with or incorporated into one or more other components. For example, a portion of the display/UI 115C may be integrated into the user device 105 or the like. In one embodiment, operations or aspects of one or more of the components discussed above may be distributed among one or more other components. Any suitable arrangement and/or integration of the various systems and devices of the environment 100 may be used.

### Exemplary Flowchart for Determining a Best Fit Claims Representative User

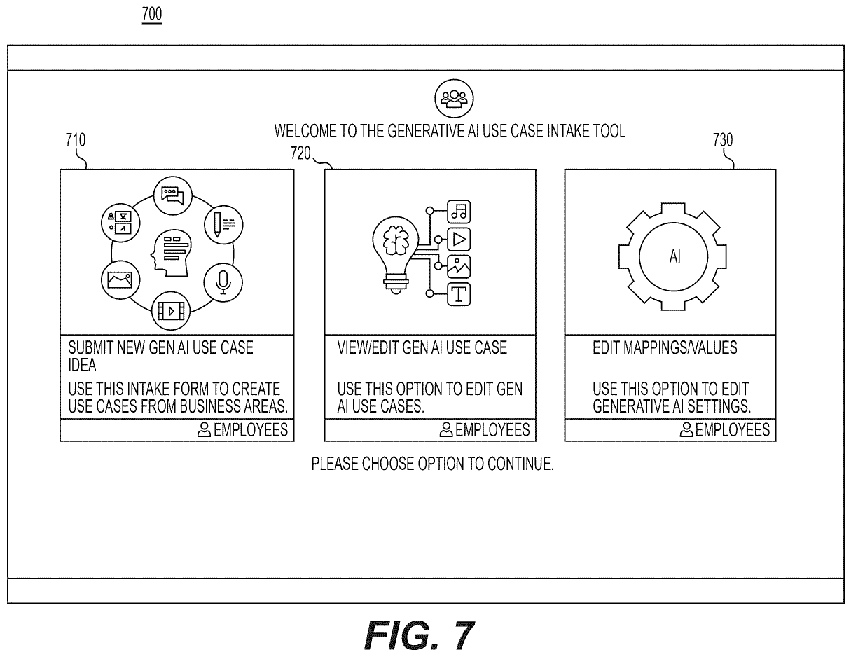

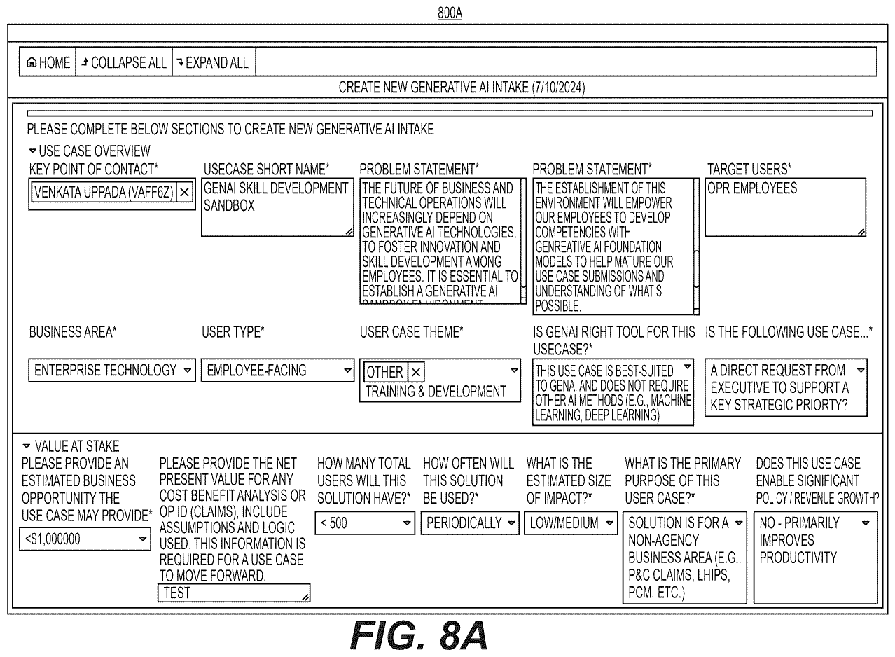

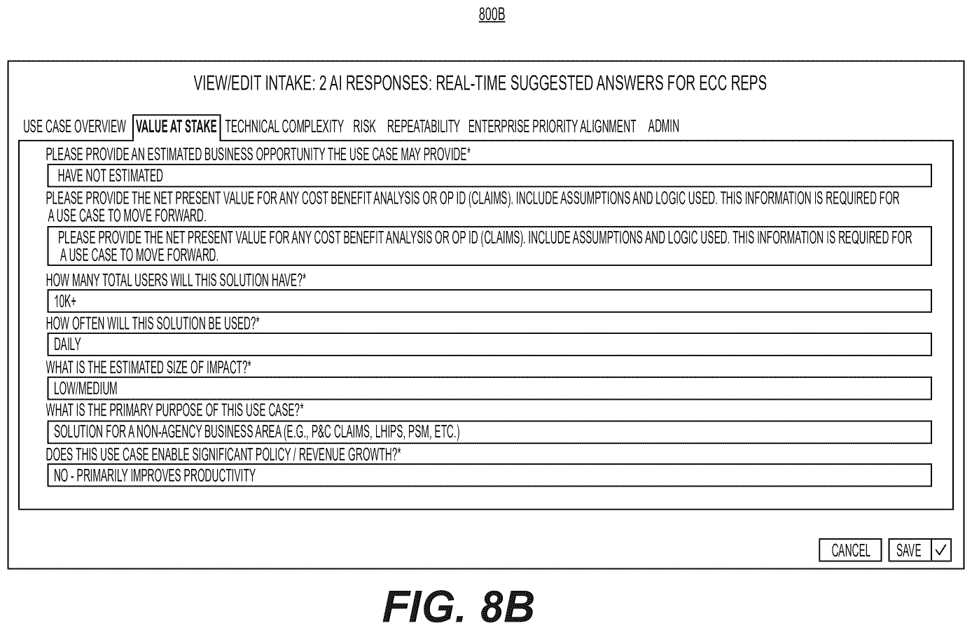

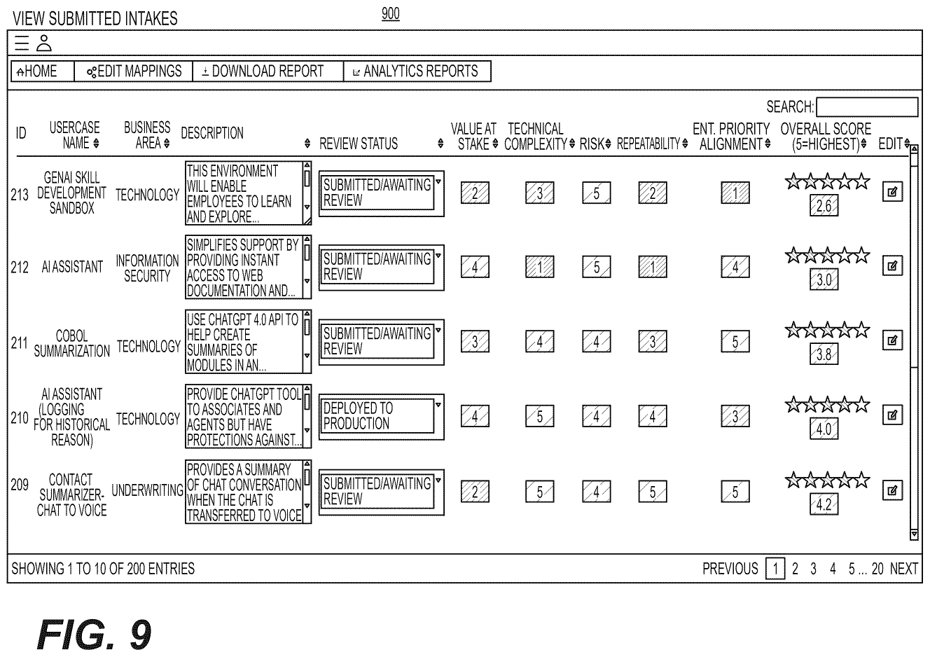

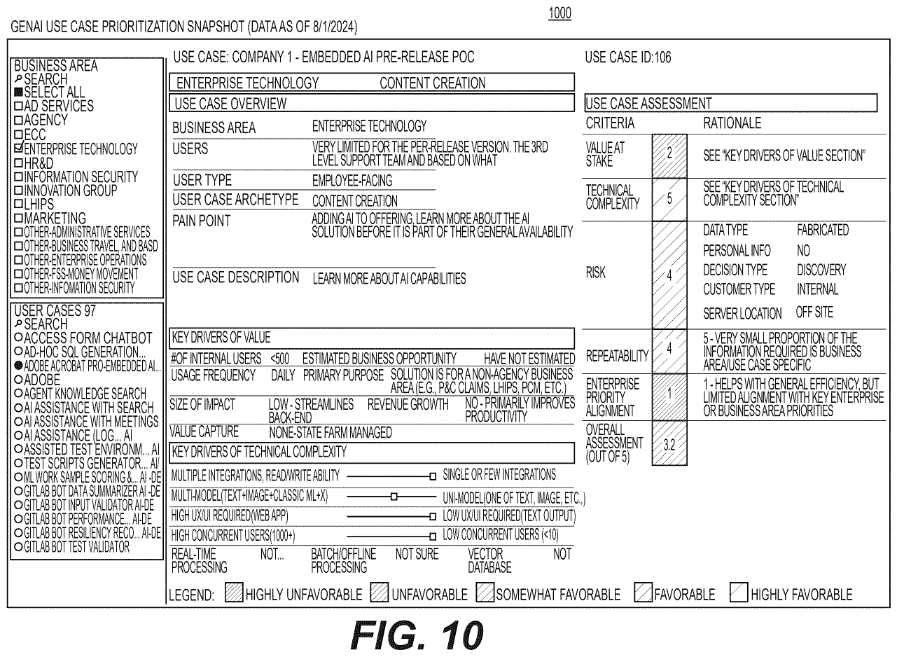

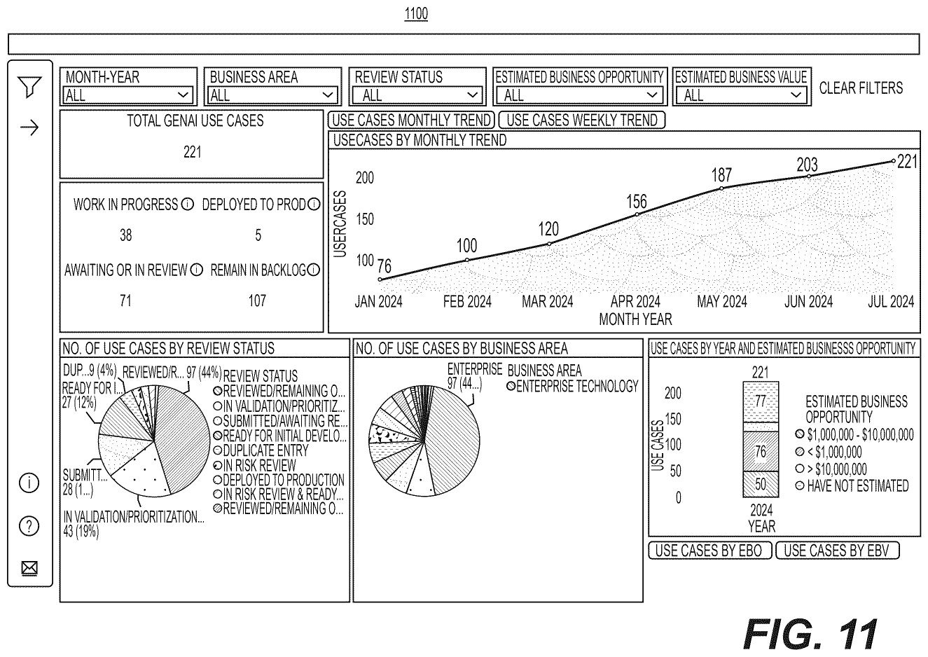

FIG. 2 depicts a diagram of an exemplary flowchart of a process 200 for intake scoring, according to one or more embodiments. Process 200 may include dashboard component 210, application programming interface (API) component 220, prioritization process component 230, storage component 240, and development component 250. Dashboard component 210 may be configured to generate and display a plurality of user interfaces during the intake process. The intake process may include user interfaces for user authentication, submission input, or the like. User interfaces relating to the intake process may be described in further detail below with respect to FIGS. 7-8B. In addition, the dashboard component 210 may be configured to generate and display insights and reports. For example, an insight user interface may provide one or more graphics that may highlight and/or indicate relationships between the business entity data and one or more intake submissions. An insight user interface may be further described below with respect to FIG. 11. A report user interface may be configured to display a summary or listing of each intake submission for a particular user. For example, the report user interface may display each of the intake submissions with corresponding information (e.g., score, status, priority, and the like.) The report user interface may further be configured to display a summary of a specific intake submission that includes a summary of a plurality of intake question and answers, ratings, status, or the like. A report user interface may be further described below with respect to FIGS. 9-10.

API component 220 may be configured to interface between a plurality of components within flow 200. For example, API component 220 may be configured to receive and transmit data from one component to the next, for example from prioritization process component 230 to development component 250. API component 220 may provide a seamless interface between the plurality of components to efficiently receive and transmit data when needed.

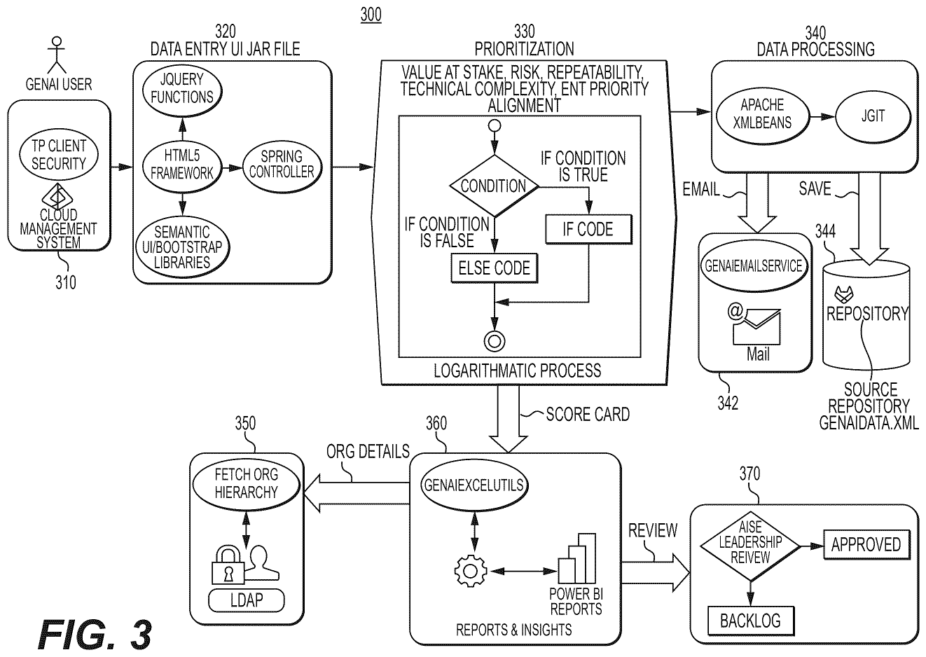

Prioritization process component 230 may be configured to score and prioritize the plurality of intake submissions. Prioritization process component 230 may be configured to receive the plurality of intake submissions from dashboard component 210 and begin the scoring and prioritization process. The scoring process may include one or more categories (e.g., value at stake, risk, repeatability, technical complexity, and/or entity priority categories) to assist in the prioritization process. The prioritization process may be described in further details below with respect to FIGS. 3-6.

Storage component 240 may be configured to store information relating to intake submissions, users, business entities, goals, or the like. For example, storage component 240 may be configured to store user information associated with one or more employees of an organization (e.g., business entity). Each user may include a data set associated with the user including at least one of: a user role, a user profile, one or more user preferences, one or more user intake submissions, and the like. The user role or profile may include additional information concerning the access restrictions or rights placed on a particular individual. The access restrictions or rights may determine the information available for access by a particular user. For example, a CEO may have full access rights to each client data set and all intake submissions. However, an employee may have limited access rights allowing a subset of client data to be accessible along with only their respective intake submissions. In addition, the business entity may include additional details about the organization and/or goals. The goals may provide insights for the prioritization process component 230 when scoring the intake submission. The goals may be configured to provide details with respect to the overall goal of the business or particular entities within the business (e.g., accounting, engineering, research and development, etc.). The goals may be dynamic in nature, needing updates to be provided to the prioritization process component 230.

Development component 250 may be configured to manage projects, code, and security. Development component 250 may be configured to manage task and feature requests. Development component 250 may include one or more applications (e.g., lightweight directory access protocol (LDAP), one or more code repositories, and/or one or more cloud management systems) to assist with the access and security permissions. Development component 250 may be configured to interact with one or more components of flow 200 as described herein.

FIG. 3 depicts a diagram of another exemplary flow for intake scoring, according to one or more embodiments. Flow 300 may include user entry 310, data entry 320, prioritization 330, data processing 340, organization hierarchy 350, reports and insights 360, and output 370. User entry 310 may be configured to receive user input relating to the intake submission process. The intake submission process may include a user accessing an application (e.g., internal intake application) from a user device (e.g., user device 105). Upon accessing the application, the user may be directed towards an authentication process. User entry 310 may include a security component and an authentication component. The security component and the authentication component may be separate components of user entry 310 or combined into a single component. The security component may be configured to provide access restrictions for each user of the application. The authentication component may be configured to determine a user role for each user of the application. A user role may include general manager, supervisor, employee, assistant, or the like. Each user role may be associated with access restrictions or limitations. Access restrictions may provide details of what content within the application may or may not be accessed by each user. Once the authentication component has determined the user role, the security component may be configured to enforce the access restrictions.

Data entry 320 may be configured to provide one or more user interfaces to the user for submitting an intake submission. For example, the one or more user interfaces may provide an intuitive web interface a plurality of forms (e.g., HTML forms) and input elements (e.g., drop down menus) configured to capture input data. Data entry 320 may include one or more components to assist the application (e.g., web interface) in providing the forms needed for a user to input data. For example, HTML5 framework may be included to provide a robust and flexible structure for the web application. HTML5 framework may support various media types, including the ability to handle multi-modal data inputs (e.g., text and image data). Cascading style sheets (CSS) may be included for styling the web application and ensuring a responsive and visually appealing user interface is displayed. CSS may enable customization and may further enhance the user experience by providing intuitive layouts and designs. Semantic user interface (UI) may be included and configured to provide a set of predesigned and customizable components that ensure a consistent and user-friendly interface. Semantic UI may further simplify the design process with a human-friendly HMTL. jQuery may be included and configured to enhance the interactivity of the web application. jQuery may further simplify document object model (DOM) manipulation, AJAx calls, and event handling, allowing for a more dynamic and responsive user interface. Spring Controller may be configured to manage the flow of data between a user interface and the backend logic of an application. Spring controller may further be configured to handle requests from the user interface, process input, and may interact with the model and database.

Prioritization 330 may be configured to automatically score and prioritize a set of scoring categories. The automated prioritization and scoring may be completed by one or more machine-learning models using backend java code. The prioritization may include a plurality of scoring categories, such as value at stake, risk, repeatability, technical complexity, and enterprise priority alignment. Each of the scoring categories may include a score that is at least partially based on the user input data, which may be aggregated for an overall score. The overall score may be critical to the prioritization process and the leadership personnel potentially implementing the business ideas expressed in an intake submission. Prioritization 330 may be further configured to perform one or more algorithms to determine a score for each scoring category. To assist in determining the score values, prioritization 330 may transmit the information to data processing 340. Once each scoring category has been provided a score in addition to an overall score, the scores may be transmitted to reports and insights 360.

Data processing 340 may be configured to receive data from prioritization 330 and determine one or more data sets required for the prioritization process. Data processing 340 may in receive and transmit information between one or more services to assist gathering the data sets. For example, a mail server 342 may be included to retrieve information relating to one or more of user data, entity, or business data or the like. In addition, source depository 344 may be included to store information relating to the intake submission process. The data sets collected may then be transmitted to prioritization 330.

Organization hierarchy 350 may be configured to provide information relating to the organization (e.g., entity or business). The information may include, but is not limited to, business information (e.g., location, resources, etc.), business goals (e.g., products, sales, etc.), personnel (e.g., general manager, supervisor, etc.), or the like. This information may be transmitted between reports and insights 360, prioritization 330, data entry 320, user entry 310, and data processing 340. For example, the information collected from organization hierarchy 350 may be used to determine a user role in user entry 310.

Reports and insights 360 may be configured to receive the one or more score values for each score category and the overall score to generate one or more reports and insights. The one or more reports may be configured to provide a summary of one or more intake submissions displayed in a user interface. The one or more insights may be configured to highlight associations between the score categories of each intake submission and the overall score. The one or more reports and insights may be presented to a user within a dashboard user interface as further described below with respect to FIG. 11.

Output 370 may be configured to receive the one or more category scores, overall score, reports, and insights from prioritization 330 and reports and insight 360. Output 370 may be configured to present the received information to one or users (e.g., leadership) for review. The one or more users may review each intake submission based on the scores received and determine an outcome. Flow 300 may automatically determine and provide the results (e.g., scores) of each intake submission to the one or more leadership personnel providing an efficient and user-friendly environment.

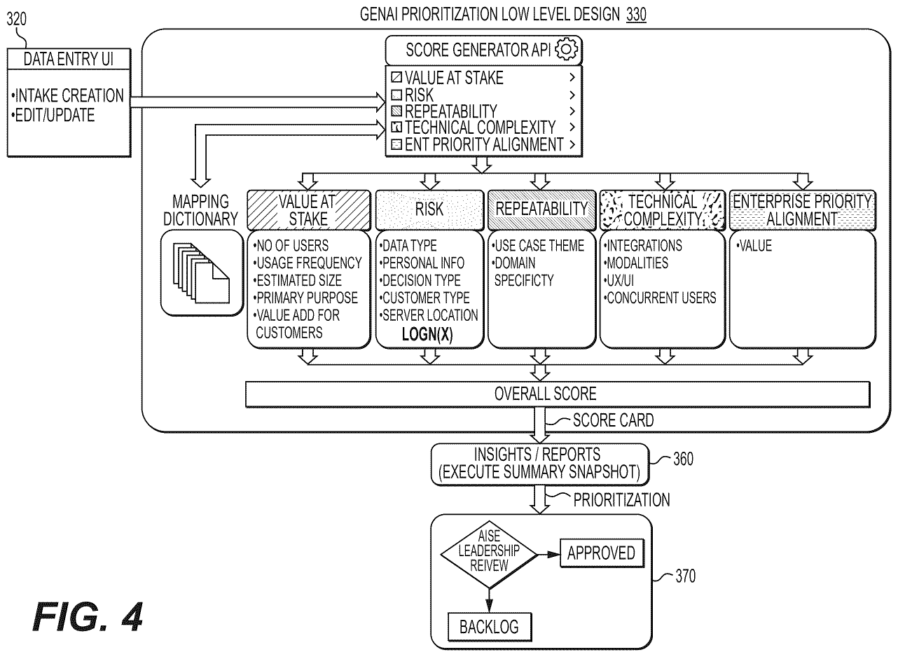

FIG. 4 depicts a prioritization diagram of an exemplary flow for intake scoring of FIG. 3, according to one or more embodiments. FIG. 4 depicts prioritization 330 of FIG. 3 as described above in greater detail. As described above, data entry 320 may initiate the intake submission process by providing a user interface to a user for inputting data relating to one or more categories of an intake submission. The data input on an intake submission may be transmitted to prioritization 330. The intake submission may be received by a score generator API, which may be configured to separate the data for each score category input on the intake submission. Each score category (e.g., value at stake, risk, repeatability, technical complexity, and enterprise priority alignment) may be individually scored and prioritized. The scoring process for each score category may differ depending on the algorithm used.

Score categories may include value at stake, risk, repeatability, technical complexity, and enterprise alignment. The value at stake score category may include one or more sub-categories including number of users, usage frequency, estimate size, primary purpose, and value added for customers. The number of users may refer to an estimated number of users to use or be affected by the proposal of the intake submission. The usage frequency may refer to an estimated frequency of use by each of the estimated users (e.g., daily, weekly, monthly, etc.). The estimated size may refer to the time, energy, and funds expected to be consumed by the proposal of the intake submission. The primary purpose may refer to the overall objective (e.g., efficiency, cost savings, etc.) by the proposal of the intake submission. The value added for customers may refer to the end user's added value (e.g., streamlines daily tasks, provides summaries of goals, etc.).

The risk score category may include one or more sub-categories including data type, personal information, decision type, customer type, and server location. The data type may refer to the type of information needed to pursue the proposal of the intake submission. Personal information may refer to the types of personal information needed to pursue the proposal of the intake submission. The decision type may refer to the types of decisions (e.g., yes, no, sliding scale, situational, etc.) needed to pursue the intake submission. The customer type may refer to the individuals who user and/or may be affected by the proposal of the intake submission. The server location may refer to the geographic location and/or the logistics of the information needed, as described above, relative to the users performing the proposal of the intake submission.

The repeatability score category may include one or more sub-categories including use case theme, domain, and specificity. The use case theme may refer to the scenario (e.g., cost savings, efficiency, job security, oversight, etc.) described in the proposal of the intake submission. The domain may refer to type of business or field (e.g., medical, financial, research, legal, etc.) described in the proposal of the intake submission. The specificity may refer to the amount of information relating to the finer details of the intake submission.

The technical complexity score category may include one or more sub-categories including integrations, modalities, UX/UI, and concurrent users. Integrations may refer to how this intake submission may be integrated into the current systems. The modalities may refer to the way or mode in which the proposal of the intake submission may be completed. UX/UI may refer to the user experience (UX) (e.g., overall experience of each user) and the user interfaces (UI) (e.g., user interactivity, look and feel, etc.) required or preferred for use within the intake submission. Concurrent users may refer to the individuals who may be affected by the proposal of the intake submission.

The enterprise priority alignment score category may include a value sub-category describing the how the proposal aligns with the current business priorities and what value it may provide to the business entity. In one embodiment, the score categories and the associated sub-categories of prioritization 330 may be dynamic and configured to be changed, updated, or modified.

In one embodiment, each score category may include the same algorithm when performing the prioritization process. For example, a category (e.g., value at stake) may be given a score value of 1 or values based on the answers provided (e.g., text data associated with the queries), whichever may be higher. In addition, an average value may be determined based on each answer provided (e.g., number of users, usage frequency, and estimated size of impact) plus a score for a primary purpose (e.g., value capture) and a potential for significant value from customers. In one embodiment, a category (e.g., technical complexity) may be given a score based on the average of answers relating to one or more topics (e.g., integrations, modalities, user interface requirements, and concurrent users). In one embodiment, a category (e.g., risk) may be given a score based on the natural log of the sum of answers relating to one or more of a data type, personal information, a decision type, a customer type, or a server location. In one embodiment, a category (e.g., repeatability) may be given a score based on an averaging a score given to one or more topics (e.g., domain specificity and selected theme). In one embodiment, a category (e.g., enterprise priority alignment) may be given a score based solely on the alignment of the input information relative to the enterprise priorities. Upon scoring each score category, an overall score may be provided. The overall score may be determined based on the average of each score category. In one embodiment, the overall score may be determined using a different algorithm, where one or more weights may be provided to each score category based on the score category aligning with the enterprise priorities.

As described above, after determining the score for each score category and the overall score, reports and insights 360 may be configured to receive the one or more score values for each score category and the overall score and then generate one or more reports and insights. Similarly, output 370 may be configured to present the information received to one or users (e.g., leadership) for review.

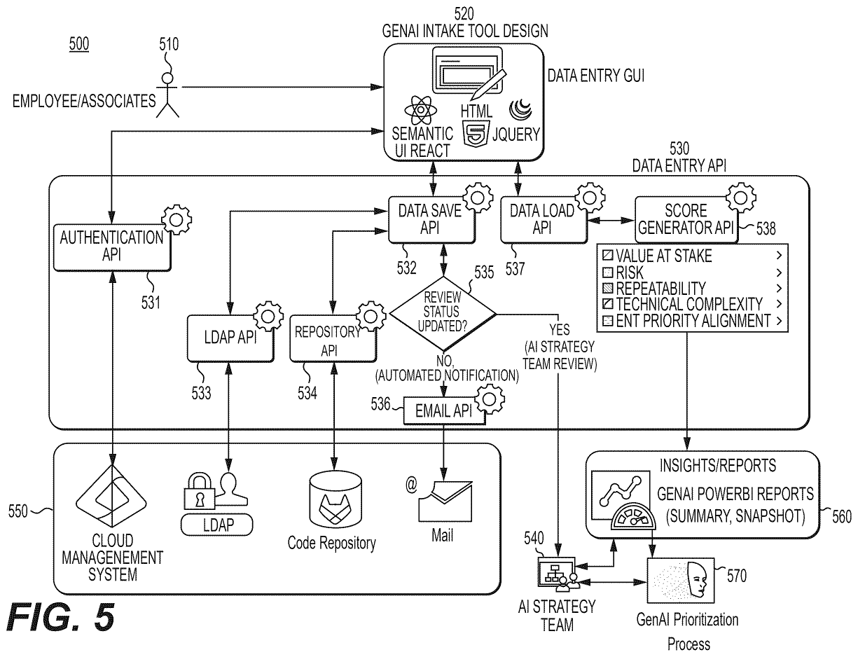

FIG. 5 depicts a diagram of another exemplary flow for process 500 for intake scoring, according to one or more embodiments. Process 500 may include user 510, intake tool 520, data entry API 530, AI strategy team 540, storage 550, reports and insights 560, and prioritization 570. User 510 may access the intake tool 520 through a user device (e.g., 105). Intake tool 520 may be configured to display one or more user interfaces to user 510. The user 510 may access an application (e.g., intake application) by providing a set of user credentials (e.g., username and password) through the intake tool 520. Intake tool 520 may request information from storage 550 (e.g., authentication component), to determine information associated with user 510. The information associated with user 510 may include a user role, a user identify, a user access permissions, or the like. Upon determining user 510 credentials, intake tool 520 may provide additional user interfaces for initiating the intake submission process. Intake tool 520 may include one or more services to provide the additional user interface. For example, HTML5 may provide a robust and flexible structure for the web application. HTML5 may support various media types, including the ability to handle multi-modal data inputs (e.g., text and image data). Semantic user interface (UI) may be included and configured to provide a set of predesigned and customizable components that ensure a consistent and user-friendly interface. Semantic UI may further simplify the design process with a human-friendly HMTL. jQuery may be included and configured to enhance the interactivity of the web application. jQuery may further simplify document object model (DOM) manipulation, AJAx calls, and event handling, allowing for a more dynamic and responsive user interface. Intake tool 520 may be configured to receive and transmit information between data entry API 530.

Data entry API 530 may be configured to interact with one or more components of flow 500 to determine the prioritization score for one or more intake submissions. Data entry API 530 may receive information from intake tool 520 and transmit the information to data save 532 and data load 537. Data save 532 may provide the information to one or more LDAPs configured to look up information and/or devices within flow 500. For example, data save 532 may transmit and receive information from LDAP within storage 550 through LDAP API 533. Data save 532 may further transmit and receive information from a code repository within storage 550 through repository API 534. Each of the APIs (e.g., LDAP API 533 and Repository API 534) may be configured to route information using a set of rules and specifications to different software applications. Each API may be application specific (e.g., LDAP API 533 for LDAP in storage 550).

Data save 532 may be configured to receive and transmit information to review status 535, which may be configured to determine if a particular intake submission has been reviewed. If review status 535 has determined that the particular intake submission has been updated, information may be transmitted to AI strategy team 540, where AI strategy team 540 may be configured to provide updates to reports and insights 560 and prioritization 570. If review status 535 has determined that the particular intake submission has not been updated, information may be transmitted to a mail application within storage 550 through email API 536. The information transmitted to the mail application may be in the form of a notification.

Data load 537 may be configured to receive and transmit information between intake tool 520 and score generator 538. Upon user 510 submitting an intake submission through intake tool 520, intake tool 520 may transmit the intake submission to score generator 538 through data load 537.

Score generator 538 may be configured to determine a score for one or more score categories of an intake submission. The one or more score categories may include values corresponding to a stake, a risk, repeatability, a technical complexity, and/or an enterprise priority alignment. Each of the score categories may be determined as discussed above with respect to prioritization 330 of FIG. 3. Upon scoring each of the score categories, score generator 538 may transmit the results back to data load 537 and to reports and insights 560.

Reports and insights 560 may be configured to receive the one or more score values for each score category from score generator 538 to generate one or more reports and insights. The one or more reports may be configured to provide a summary of one or more intake submissions displayed in a user interface. The one or more insights may be configured to highlight associations between the score categories of each intake submission and the overall score. The one or more reports and insights may be presented to a user within a dashboard user interface as further described below with respect to FIG. 11. The one or more reports and insights may be transmitted between AI strategy team 540 and prioritization 570 for further review. Reports and insights 560 may update one or more reports and insights based on receiving updated information from AI strategy team 540 or prioritization 570.

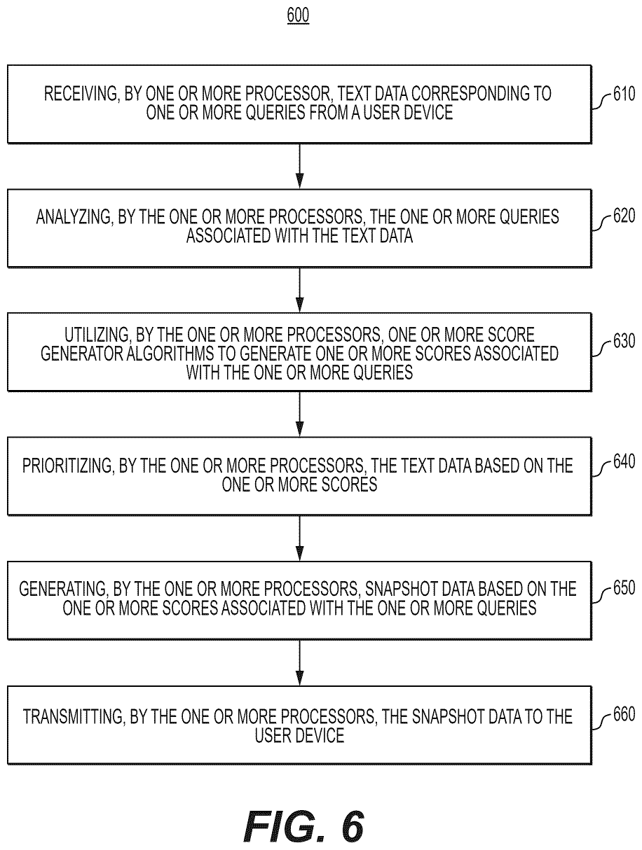

FIG. 6 depicts a flowchart of an exemplary method 600 for intake scoring, according to one or more embodiments. Notably, method 600 may be performed by one or more processors of a server that is in communication with a user device (e.g., user device 105), an external system (e.g., external system 110), or the like. However, it should be noted that the method may be performed by any one or more of the server, one or more user devices, one or more external systems, and/or other systems.

The method may include receiving, by one or more processors, text data corresponding to one or more queries from a user device (e.g., user device 105) (Step 610). The text data may include one or more text strings, one or more character strings, or the like. The text data may correspond to a user's description of one or more sections of an intake submission. The one or more queries may correspond to the one or more sub-sections of the intake submission. The intake submission may include data that describes the intake submission, wherein the intake submission includes a plurality of sections and sub-sections. The plurality of sections and sub-sections of the intake submission may provide areas of interest, for example, key point of contact, use case, problem statement(s), target users, business area, user type, user case theme, use case scenarios, and the like.

In one embodiment, a user may input the text data into the user device to initiate an intake submission process. For example, a user may initiate the intake submission process by filling in an intake submission form via the user device (e.g., user device 105) to the intake system (e.g., server system 115). A data entry system may receive the intake submission and transmit the intake submission to the intake system. The intake submission may include information pertaining to the key point of contact, use case, problem statement(s), target users, business area, or the like.

In one embodiment, before step 610, the method may include authenticating, by the one or more processors, a user of the user device. Before the user may input text data corresponding to the one or more queries, the system may verify the user. The verification process may include authenticating the user via a username and password combination, other authentication methods may be used in place of, or in addition to, the authentication method described herein. Upon being authenticated, the system may further include determining, by the one or more processors, a user role based on the authenticating. For example, based on the username and password combination, the system may determine the user role. The user role may include general manager, supervisor, employee, assistant, or the like. The user role may be associated with certain access restrictions or limitations. For example, the general manager may not have any access restrictions whereas an assistant may include very limiting access restrictions. Upon determining the user role, the method may further include determining, by the one or more processors, the one or more queries based on the user role. Each query may be user role specific or include a first portion of queries that are general to all intake submissions and a second portion that are user role specific. The one or more queries may assist in facilitating the intake submission process as described herein.

The method may include analyzing, by the one or more processors, the one or more queries associated with the text data (Step 620). For example, a machine-learning model (e.g., utilizing a CNN) may receive the text data from the system and determine one or more categories based on the text data. The one or more machine-learning models may have been previously trained to determine contextual information from the text data (e.g., business goals, target users, risk, etc.). For example, the text data may be segmented and/or parsed to determine one or more context items. Context items may include, but are not limited to, business information relating to goals for each area within the business, scoring categories (e.g., value, risk, repeatability, etc.), an effect the submission has on the business, and/or whether the submission aligns with business goals. The text data may be received by a server system (e.g., server system 115) from a user device (e.g., user device 105) using a messaging system (e.g., SMS messaging, chat messaging) in a first format and the machine-learning model may convert the text data from the first format to a second format when generating the one or more categories. The first format may include an informational format (e.g., text and/or character strings) based on manual input and/or automatically generated data (e.g., user text input). The second format may include a machine-readable format that may be provided as input to one or more machine-learning models for determining associations. Converting the first format to the second format may include adding known associations between different characteristics. The characteristics may correspond to one or more of the context items, where the associations may correspond to one or more relationships between the context items. For example, the text data may include information relating to a set of products and/or a consumer report. The machine-learning model may determine one or more associations, where each product within the set is ranked based on a current consumer report. In comparison to the first format, such associations may be more easily analyzed by the machine-learning models. The second format may include, for example, a JSON file, XML file, or the like.

The method may include utilizing, by the one or more processors, one or more score generator algorithms to generate one or more scores associated with the one or more queries (Step 630). For example, the system may retrieve the one or more score generator algorithms to generate a score for one or more score categories. The one or more score categories may include value at stake, risk, repeatability, technical complexity, business entity priority/alignment (e.g., enterprise), or the like. Each of the one or more score categories may include an individualized algorithm specific to the score category. The one or more score categories may include a pass or fail (e.g., logic 1 or logic 0), a natural log algorithm, averaging, or the like. In one embodiment, one or more algorithms may be used for each score category. For example, a single category (e.g., value at stake) may be given a score value of 1 or values based on the answers (e.g., text data associated with the queries), whichever may be higher. In addition, an average may be determined based on each answer provided (e.g., number of users, usage frequency, estimated size of impact) plus a score for a primary purpose (e.g., value capture) and a potential for significant value from customers. In one embodiment, a score may be determined based on the average of answers relating to one or more of integrations, modalities, user interface requirements, concurrent users. In one embodiment, a score may be determined based on the natural log of the sum of answers relating to data type, personal information, decision type, customer type, or server location. The generation of scores as described herein may be determined by one or machine-learning models as described herein.

The method may include prioritizing, by the one or more processors, the test data based on the one or more scores (Step 640). For example, the system may rank or arrange each of the score categories according to the respective score. An overall score may be determined based on the prioritization of each category. In one embodiment, each score category may be prioritized differently based on the business entity and current business goals. As the business evolves overtime, the business entity and current business goals may change, therefore different score categories may shift within the prioritization at different times. The business goals may be a function of sub-groups of the business. For example, research and development may include different business goals than that of marketing. Research and development may have goals relating to perfecting a specific product before releasing it to the public. However, marketing may have goals that relate to a specific set of products and the anticipated release dates.

The method may include generating, by the one or more processors, snapshot data based on the one or more scores associated with the one or more queries (Step 650). For example, snapshot data may include aggregating the one or more scores associated with the one or more queries and determining an overall score. The system may aggregate each score category to define an overall score for the intake submission. The overall score may include a representation of the intake submission to assist in ranking the intake submission versus all other intake submissions. As previously described, each score category may be dynamic in nature based on the business entity and associate goals. The overall score for each intake submission may change due to the changes in the business entity and their associated goals. The snapshot data may represent the current values provided based on the determined business entity and associated goals. In addition, the snapshot data may be displayed in one or more user interfaces as discussed in further details below with respect to FIGS. 9-11.

Finally, the method may include transmitting, by the one or more processors, the snapshot data to the user device (Step 660). For example, upon generating the snapshot data, the snapshot data and corresponding information (e.g., text data and graphic data) may be provided, among other things, to a user device (e.g., user device 105) to a dashboard user interface as described in further detail below with respect to FIGS. 9-11.

Although FIG. 6 shows example blocks of exemplary method 600, in some implementations, the exemplary method 600 may include additional blocks, fewer blocks, different blocks, or differently arranged blocks than those depicted in FIG. 6. Additionally, or alternatively, two or more of the blocks of the exemplary method 600 may be performed in parallel.

### Exemplary User Interfaces

FIG. 7 depicts an exemplary welcome user interface 700 for intake scoring, according to one or more embodiments. User interface 700 may be representative of an exemplary welcome page for a user. User interface 700 may be displayed upon the user entering user authentication information (e.g., username and password). User interface 700 may include a new intake window 710, a view intakes window 720, and/or settings window 730. The new intake window 710 may be configured for user selection to access a new intake form as described in more detail with respect to FIG. 8A. The view intakes window 720 may be configured, upon selection, to provide an interface for the user the view and/or edit previously stored intake submissions. The view intakes window 720 may be described in further detail with respect to FIG. 8B. The settings window 730 may be configured, upon selection, to provide a user interface to allow the user to update and/or change user settings. The user settings may include, but are not limited to, user authentication information (e.g., username and/or password), user preferences, user interface layout and/or arrangement(s), or the like.

FIGS. 8A and 8B depict exemplary user interfaces 800A and 800B for intake scoring, according to one or more embodiments. FIG. 8A depicts a new intake user interface 800A. The new intake user interface 800A may be displayed upon selection of the new intake window 710 as described above with respect to FIG. 7. The new intake user interface 800A may include one or more sections for a user to input information relating to a new intake submission. The one or more sections of the new intake user interface 800A may include point of contact, business area, problem statement, or the like. In addition, the new intake user interface may further include one or more scoring categories as described above. The one or more scoring categories may include value at stake, risk, repeatability, technical complexity, and priority alignment. The new intake user interface 800A may include additional questions or queries relating to the one or more scoring categories to further define each category. The one or more questions may be dynamically provided based on previously supplied inputs of the user within the new intake user interface 800A. For example, if a user supplies information relating to the target user being current employees versus end users, the system may alter the one or more scoring category questions accordingly.

FIG. 8B depicts a view intake user interface 800B. The view intake user interface 800B may be displayed upon selection of the view intakes window 720 as described above with respect to the FIG. 7. The view intake user interface 800B may include a tab or section relating to each of the one or more scoring categories. Upon selection of a scoring category, the view intake user interface 800B may display the information inputted by the user. For example, the value at stake scoring category tab may be selected. Upon selection, the view intake user interface 800B may display the one or more questions and responses relating to the value at stake scoring category. The user may be allowed to edit any of the responses to update the intake submission.

FIG. 9 depicts an exemplary user submission dashboard user interface, according to one or more embodiments. A view submitted intakes user interface 900 may be displayed in response to a user selection from a user dashboard (e.g., user interface 700), a homepage of the user dashboard, or through a series of selections within the user dashboard. The view submitted user interface 900 may be configured to view and edit previously submitted intake submissions. The view submitted user interface 900 may include section information relating to categories on the intake submission (e.g., user case name, business area, description, review status, etc.). Each section may include toggleable filters to rearrange or reorder each section within the view submitted user interface 900.

Each submission may be arranged in a single row with the corresponding information (e.g., section information) in a plurality of columns. Each row may correspond to a single submitted intake submission. In at least a subset of the plurality of columns, the plurality of scoring category information may be displayed. Each category within the plurality of scoring categories may include a graphic and/or text indicia. The graphic and/or indicia may provide a quick reference to each of the scoring categories and the respective score. The score may be representative of the individual category and be provided with a color coding or additional graphic to provide a quick reference of the score relative to a scoring range. The scoring range as described herein may be 0-5, however different scoring ranges may be used. Each submission may further include an edit icon configured to display a user interface for editing the intake submission. The user interface may be similar to view intake user interface 800B as described above with respect to FIG. 8B.

FIG. 10 depicts an exemplary user submission interface, according to one or more embodiments. FIG. 10 depicts a snapshot user interface 1000. Snapshot user interface 1000 may be configured to display a submitted intake submission. The snapshot user interface 1000 may be displayed in response to a selection of an intake submission of FIG. 9. The snapshot user interface 1000 may include an overview of the intake submission including, but not limited to, a summary of each section of the intake submission, each scoring category and the corresponding score, a graphical representation and/or text indicia relating to the scoring category, a legend, or the like.

FIG. 11 depicts an exemplary metrics dashboard user interface for intake scoring, according to one or more embodiments. FIG. 11 depicts a metric dashboard user interface 1100. The metric dashboard user interface 1100 may be configured to display an overview of an aggregation of the intake submissions of a particular user. The metric dashboard user interface 1100 may include one or more sections related to at least one of total intake submissions, status of each intake submission, outcome of each submission, or one or more graphics. The one or more graphics may include summaries of the one or more sections, where the graphic may be a pie chart, bar graph, line graph, or the like. The metric dashboard user interface 1100 may provide a quick overview of the submitted intake submissions by highlighting an aggregation of the intake submissions in an efficient and seamless manner.

### Exemplary Machine-learning Techniques

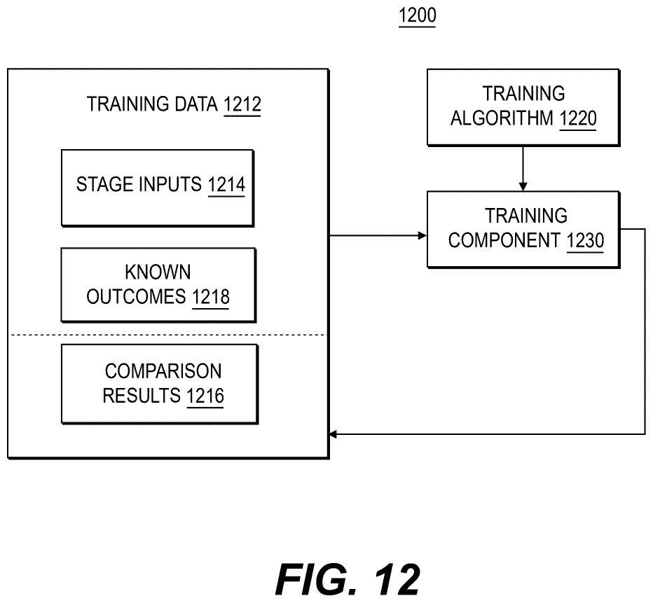

FIG. 12 depicts a flowchart of an exemplary method for training a machine-learning model to score intake submissions, according to one or more embodiments. One or more implementations disclosed herein include and/or may be implemented using a machine-learning model. For example, one or more devices (e.g., user device 105) of the environment 100 may be implemented using a machine-learning model and/or may be used to train the machine-learning model. A given machine-learning model may be trained using the data flow 1200 of FIG. 12. Training data 1212 may include one or more of stage inputs 1214 and known outcomes 1218 related to the machine-learning model to be trained. The stage inputs 1214 may be from any applicable source including text, visual representations, data, values, comparisons, and stage outputs, e.g., one or more outputs from one or more actions or operations from FIGS. 2 to 6. The known outcomes 1218 may be included for the machine-learning models generated based upon supervised or semi-supervised training. An unsupervised machine-learning model may not be trained using known outcomes 1218. Known outcomes 1218 may include known or desired outputs for future inputs similar to or in the same category as stage inputs 1214 that do not have corresponding known outputs.

The training data 1212 and a training algorithm 1220, e.g., one or more of the modules implemented using the machine-learning model and/or may be used to train the machine-learning model, may be provided to a training component 1230 that may apply the training data 1212 to the training algorithm 1220 to generate the machine-learning model. According to an implementation, the training component 1230 may be provided comparison results 1216 that compare a previous output of the corresponding machine-learning model to apply the previous result to re-train the machine-learning model. The comparison results 1216 may be used by training component 1230 to update the corresponding machine-learning model. The training algorithm 1220 may utilize machine-learning networks and/or models including, but not limited to a deep learning network such as Deep Neural Networks (DNN), Convolutional Neural Networks (CNN), Fully Convolutional Networks (FCN), and Recurrent Neural Networks (RNN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 2-6, may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIGS. 2-6 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

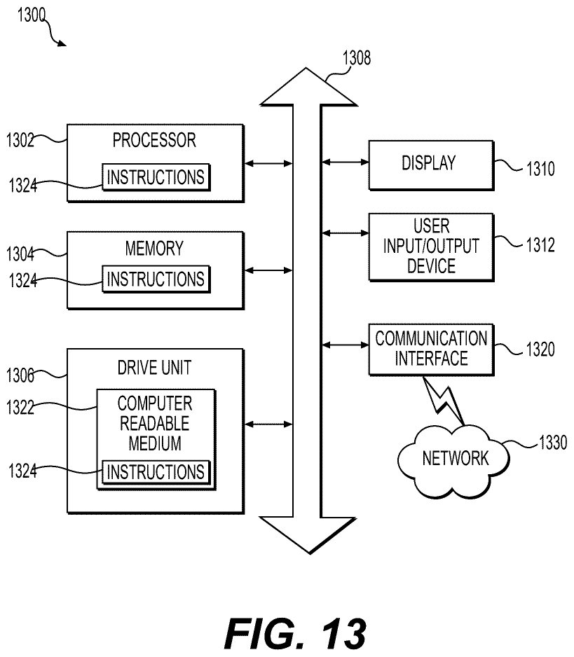

FIG. 13 depicts an exemplary computer system that may execute techniques presented herein, according to one or more embodiments. The computer system 1300 can include a set of instructions that can be executed to cause the computer system 1300 to perform any one or more of the methods or computer-based functions disclosed herein. The computer system 1300 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 1300 may operate in the capacity of a server or as a client user computer in a server-client user network environment, or as a peer computer system in a peer-to-peer (or distributed) network environment. The computer system 1300 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 1300 may be implemented using electronic devices that provide voice, video, or data communication. Further, while the computer system 1300 is illustrated as a single system, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, e.g., a central processing unit (CPU), a graphics processing unit (GPU), or both. The processor 1302 may be a component in a variety of systems. For example, the processor 1302 may be part of a standard personal computer or a workstation. The processor 1302 may be one or more processors, digital signal processors, application specific integrated circuits, field programmable gate arrays, servers, networks, digital circuits, analog circuits, combinations thereof, or other now known or later developed devices for analyzing and processing data. The processor 1302 may implement a software program, such as code generated manually (i.e., programmed).

The computer system 1300 may include a memory 1304 that can communicate via bus 1308. The memory 1304 may be a main memory, a static memory, or a dynamic memory. The memory 1304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1304 may include a cache or random-access memory for the processor 1302. In alternative implementations, the memory 1304 is separate from the processor 1302, such as a cache memory of a processor, the system memory, or other memory.

The memory 1304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1304 is operable to store instructions executable by the processor 1302. The functions, acts or tasks illustrated in the figures or described herein may be performed by the processor 1302 executing the instructions stored in the memory 1304. The functions, acts, or tasks are independent of the particular type of instruction set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

As shown, the computer system 1300 may further include a display 1310, such as a liquid crystal display (LCD), an organic light emitting diode (OLED), a flat panel display, a solid-state display, a cathode ray tube (CRT), a projector, a printer or other now known or later developed display device for outputting determined information. The display 1310 may act as an interface for the user to see the functioning of the processor 1302, or specifically as an interface with the software stored in the memory 1304 or in the drive unit 1306.

Additionally or alternatively, the computer system 1300 may include an input/output device 1312 configured to allow a user to interact with any of the components of the computer system 1300. The input/output device 1312 may be a number pad, a keyboard, or a cursor control device, such as a mouse, or a joystick, touch screen display, remote control, or any other device operative to interact with the computer system 1300.

The computer system 1300 may also or alternatively include drive unit 1306 implemented as a disk or optical drive. The drive unit 1306 may include a computer-readable medium 1322 in which one or more sets of instructions 1324, e.g., software, can be embedded. Further, instructions 1324 may embody one or more of the methods or logic as described herein. The instructions 1324 may reside completely or partially within the memory 1304 and/or within the processor 1302 during execution by the computer system 1300. The memory 1304 and the processor 1302 also may include computer-readable media as discussed above.

In some systems, computer-readable medium 1322 includes the set of instructions 1324 or receives and executes the set of instructions 1324 responsive to a propagated signal so that a device connected to network 1330 can communicate voice, video, audio, images, or any other data over the network 1330. Further, the set of instructions 1324 may be transmitted or received over the network 1330 via communication port or interface 1320, and/or using bus 1308. The communication port or interface 1320 may be a part of the processor 1302 or may be a separate component. The communication port or interface 1320 may be created in software or may be a physical connection in hardware.

The communication port or interface 1320 may be configured to connect with a network 1330, external media, the display 1310, or any other components in computer system 1300, or combinations thereof. The connection with the network 1330 may be a physical connection, such as a wired Ethernet connection or may be established wirelessly as discussed below. Likewise, the additional connections with other components of the computer system 1300 may be physical connections or may be established wirelessly. The network 1330 may alternatively be directly connected to the bus 1308.

While the computer-readable medium 1322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 1322 may be non-transitory, and may be tangible.

The computer-readable medium 1322 can include a solid-state memory such as a memory card or other package that houses one or more non-volatile read-only memories. The computer-readable medium 1322 can be a random-access memory or other volatile re-writable memory. Additionally, or alternatively, the computer-readable medium 1322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 1300 may be connected to network 1330. The network 1330 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 1330 may include wide area networks (WAN), such as the Internet, local area networks (LAN), campus area networks, metropolitan area networks, a direct connection such as through a Universal Serial Bus (USB) port, or any other networks that may allow for data communication.

The network 1330 may be configured to couple one computing device to another computing device to enable communication of data between the devices. The network 1330 may generally be enabled to employ any form of machine-readable media for communicating information from one device to another. The network 1330 may include communication methods by which information may travel between computing devices.

The network 1330 may be divided into sub-networks. The sub-networks may allow access to all of the other components connected thereto or the sub-networks may restrict access between the components. The network 1330 may be regarded as a public or private network connection and may include, for example, a virtual private network or an encryption or other security mechanism employed over the public Internet, or the like.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for intake scoring, the computer-implemented method comprising:
receiving, by one or more processors, text data corresponding to one or more queries from a user device;
analyzing, by the one or more processors, the one or more queries associated with the text data;
utilizing, by the one or more processors, one or more score generator algorithms to generate one or more scores associated with the one or more queries;
prioritizing, by the one or more processors, the text data based on the one or more scores;
generating, by the one or more processors, snapshot data based on the one or more scores associated with the one or more queries; and
transmitting, by the one or more processors, the snapshot data to the user device.

2. The computer-implemented method of claim 1, where prior to receiving the text data, the computer-implemented method further comprises:
authenticating, by the one or more processors, a user of the user device;
determining, by the one or more processors, a user role based on the authenticating; and
determining, by the one or more processors, the one or more queries based on the user role.

3. The computer-implemented method of claim 1, wherein analyzing the text data further includes:
generating, by the one or more processors, one or more categories associated with the text data.

4. The computer-implemented method of claim 1, wherein the one or more scores include at least one of: a value at stake score, a technical complexity score, a risk score, a repeatability score, and an enterprise score.

5. The computer-implemented method of claim 1, wherein generating the snapshot data further includes:
aggregating, by the one or more processors, the one or more scores associated with the one or more queries; and
determining, by the one or more processors, an overall score.

6. The computer-implemented method of claim 1, wherein the snapshot data is configured for access through a dashboard associated with a user, the dashboard including at least one of: a set of one or more graphs representing an aggregation of one or more user submissions.

7. The computer-implemented method of claim 1, wherein generating the snapshot data includes presenting a plurality of submissions based on a user role, wherein the plurality of submissions include at least one of: one or more user submissions or one or more submissions for user review.

8. A system for prioritization scoring, the system comprising:
a memory storing instructions;
one or more machine-learning models trained to determine prioritization scoring;
a processor operatively connected to the memory and configured to execute instructions to perform:
receiving text data corresponding to one or more queries from a user device;
analyzing the one or more queries associated with the text data;
utilizing one or more score generator algorithms to generate one or more scores associated with the one or more queries;
prioritizing the text data based on the one or more scores;
generating snapshot data based on the one or more scores associated with the one or more queries; and
transmitting the snapshot data to the user device.

9. The system of claim 8, where prior to receiving the text data, the instructions further comprises:
authenticating a user of the user device;
determining a user role based on the authenticating; and
determining the one or more queries based on the user role.

10. The system of claim 8, wherein analyzing the text data further includes:
generating one or more categories associated with the text data.

11. The system of claim 8, wherein the one or more scores include at least one of: a value at stake score, a technical complexity score, a risk score, a repeatability score, and an enterprise score.

12. The system of claim 8, wherein generating the snapshot data further includes:
aggregating the one or more scores associated with the one or more queries; and
determining an overall score.

13. The system of claim 8, wherein the snapshot data is configured for access through a dashboard associated with a user, the dashboard including at least one of: a set of one or more graphs representing an aggregation of one or more user submissions.

14. The system of claim 8, wherein generating the snapshot data includes presenting a plurality of submissions based on a user role, wherein the plurality of submissions include at least one of: one or more user submissions or one or more submissions for user review.

15. A non-transitory computer readable medium configured to store processor readable instructions, wherein when executed by a processor, the instructions perform operations comprising:
receiving text data corresponding to one or more queries from a user device;
analyzing the one or more queries associated with the text data;
utilizing one or more score generator algorithms to generate one or more scores associated with the one or more queries;
prioritizing the text data based on the one or more scores;
generating snapshot data based on the one or more scores associated with the one or more queries; and
transmitting the snapshot data to the user device.

16. The non-transitory computer readable medium of claim 15, where prior to receiving the text data, the instructions further comprises:
authenticating a user of the user device;
determining a user role based on the authenticating; and
determining the one or more queries based on the user role.

17. The non-transitory computer readable medium of claim 15, wherein analyzing the text data further includes:
generating one or more categories associated with the text data.

18. The non-transitory computer readable medium of claim 15, wherein the one or more scores include at least one of: a value at stake score, a technical complexity score, a risk score, a repeatability score, and an enterprise score.

19. The non-transitory computer readable medium of claim 15, wherein generating the snapshot data further includes:
aggregating the one or more scores associated with the one or more queries; and
determining an overall score.

20. The non-transitory computer readable medium of claim 15, wherein the snapshot data is configured for access through a dashboard associated with a user, the dashboard including at least one of: a set of one or more graphs representing an aggregation of one or more user submissions.
